(19) United States
(12) Patent Application Publication
(10) Pub. No.: US 2007/0239717 A1
(43) Pub. Date: Oct. 11, 2007

(54) System and method for architecting pattern based models within a governmental framework

(75) Inventors: Ralph W. Thrash, Knoxville, MD (US); Victor L. Harrison, Davidsonville, MD (US)

Correspondence Address: HOFFMAN, WARNICK & D'ALESSANDRO LLC, 75 STATE ST, 14 FL, ALBANY, NY, 12207, US

(73) Assignees: International Business Machines Corporation, Armonk, NY (US); Computer Sciences Corporation, Fairfax, VA (US)

(21) Appl. No.: 11/217,641

(22) Filed: Sep. 1, 2005

(51) Int. Cl. G06F 17/30

(52) U.S. Cl. 707/7

(57) ABSTRACT

A system and method for processing patterns that provides technological implementation details of an enterprise application within the context of a public-sector enterprise reference model framework. A system is disclosed that includes: an architecture product library having patterns that define reusable assets for use in modeling enterprise applications; a framework integration system that defines a subset of patterns from the architecture product library for a predefined enterprise reference model framework; and a system for modeling an enterprise application within the context of the predefined enterprise reference model framework by using patterns selected from the subset of patterns.

This invention was made with Government support under Contract No. MDA90403C1465 awarded by the Department of Defense. The Government has certain rights in this invention.

### BACKGROUND OF THE INVENTION

1. Technical Field

The present invention relates generally to architecting an information technology system design within the context of a governmental framework, and more specifically relates to a system and method for architecting an information technology system design within the confines of a governmental framework using patterns that are relevant to a selected framework.

2. Related Art

In accordance with governmental regulations, such as the Clinger-Cohen Act of 1996, public sector information technology systems are required to be designed in accordance with a defined enterprise reference model framework. The most common examples include the Federal Enterprise Architecture Framework (FEAF), the Department of Defense Architecture Framework (DODAF) and the Treasury Enterprise Architecture Framework (TEAF). Each of these frameworks generally provides both a high level description of the framework objectives and lower level descriptions, such as logical structures for classifying and organizing artifacts.

Unfortunately, these enterprise reference model frameworks provide only limited guidance on bridging high level business objectives with the physical realization of the objectives within a technology fabric. Instead, it is typically left up to the contractor to architect a solution that both meets the business needs of the government agency and meets the specifications of the relevant framework. Lacking a disciplined approach, the higher order public sector frameworks rely on a myriad of potential approaches that foster application of first order principles in the manufacture and manifestation of solution architectures to support business goals. Such an approach is costly in terms of the time it takes to architect a system, as well as the overall consistency of the quality. Accordingly, a need exists for a more uniform approach to architecting solutions within the context of a public sector enterprise reference model framework.

### SUMMARY OF THE INVENTION

The present invention addresses the above-mentioned problems, as well as others, by providing a system and method for the engineered application of pleomorphic enterprise architecture archetype reference meta-models (i.e., architecture patterns) in a structured and re-usable manner within a selected public sector enterprise reference model framework. The invention provides a bridge within public sector enterprise reference model frameworks that assures successful technical integration and association of the technological underpinnings of an architected IT solution to a business or mission function.

More particularly, the invention provides a system for applying patterns that provide technological implementation details of an enterprise application, which includes, e.g., a description of the enterprise's technological architecture components. The invention utilizes an architecture product library having architecture patterns that define reusable assets for use in modeling large grained (“upper case”) enterprise components and systems; a framework integration system that defines, selects, and applies a subset of finer grained (“lower case”) architecture design patterns from the architecture product library appropriate for describing a predefined enterprise reference model framework; and a system for applying patterns from the subset of finer grained architecture design patterns to the business/mission, service, interface and data aspects of an enterprise application within the context of the predefined enterprise reference model framework.

In a first aspect, the invention provides a system for processing patterns that provide technological implementation details of an enterprise application, comprising: an architecture product library having patterns that define reusable assets for use in modeling enterprise components and systems; a framework integration system that defines a subset of patterns from the architecture product library for a predefined enterprise reference model framework; and a system for modeling an enterprise application within the context of the predefined enterprise reference model framework by using patterns selected from the subset of patterns.

In a second aspect, the invention provides a computer program product stored on a computer readable medium for processing patterns that provide technological implementation details of an enterprise application, comprising: program code configured for accessing an architecture product library having patterns that define reusable assets for use in modeling enterprise components and systems; and program code configured for defining a subset of patterns from the architecture product library for a predefined enterprise reference model framework.

In a third aspect, the invention provides a method for processing patterns that provide technological implementation details of an enterprise application, comprising: providing an architecture product library having patterns that define reusable assets for use in modeling enterprise components and systems; defining a subset of patterns from the architecture product library for a predefined enterprise reference model framework; and modeling an enterprise application within the context of the predefined enterprise reference model framework by using patterns selected from the subset of patterns.

In a fourth aspect, the invention provides a method for deploying an application for an architecture pattern processing system, comprising: providing a computer infrastructure being operable to: access an architecture product library having patterns that define reusable assets for use in modeling enterprise components and systems; define a subset of patterns from the architecture product library for a predefined enterprise reference model framework; and model an enterprise application within the context of the predefined enterprise reference model framework by using patterns selected from the subset of patterns.

In a fifth aspect, the invention provides computer software embodied in a propagated signal for implementing pattern processing system, the computer software comprising instructions to cause a computer to perform the following functions: access an architecture product library having patterns that define reusable assets for use in modeling enterprise components and systems; and define a subset of patterns from the architecture product library for a predefined enterprise reference model framework.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a pattern generation system in accordance with the present invention.

FIG. 2 depicts an illustrative fine grain (“lower case”) design pattern.

FIG. 3 depicts an object-oriented view of the pattern generation system of FIG. 1.

### DETAILED DESCRIPTION OF THE INVENTION

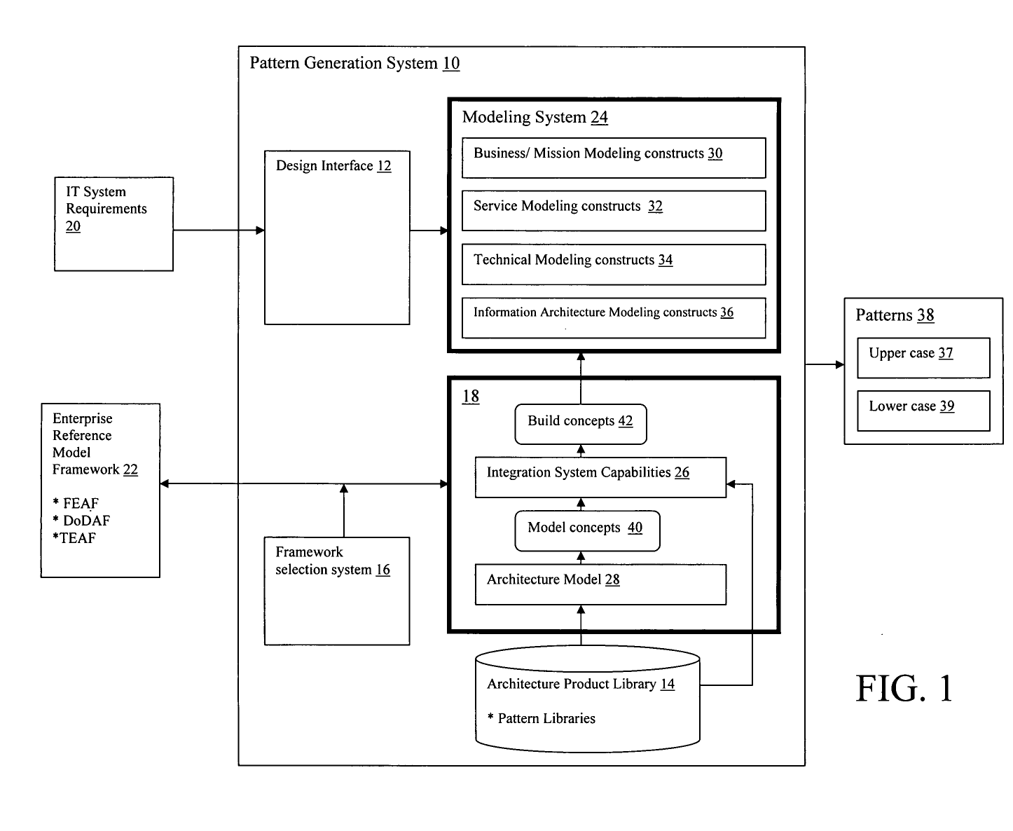

Referring now to the drawings, FIG. 1 depicts a pattern generation system 10 for generating patterns 38 based on a set of information technology (IT) system requirements 20 and a selected enterprise reference model framework 22. While the use of patterns 38 are well known in the art of application development, the present invention provides a system that can generate patterns 38 that meet the design requirements of any now known or later developed enterprise reference model framework 22. Thus, the embodiments described herein provide a platform that allows system designers, who are required to architect a public-sector enterprise application, the ability to identify and generate meta-models (i.e., patterns) that define a desired technical implementation of the application, and which meet the relevant legal requirements set forth in the framework. As described below, pattern generation system 10 includes an application technique for applying patterns to various modeling constructs that can be linked to a selected enterprise reference model framework 22.

As is known in the art, patterns provide a set of reusable assets that can speed the process of developing IT systems, such as Web applications. In this illustrative embodiment, patterns may fall into one of two general categories, “upper case,” and “lower case.” Upper case patterns 37 refer to higher level patterns that exist at the business/mission and technical levels (e.g., a pattern that defines a web portal for doing on-line retail transactions using Web services). Lower case patterns 39 refer to the more fine grain design details of the technical modeling process (e.g., Gang of Four and Fowler patterns).

IBM's patterns for e-business, described in detail at the Web address, http://www-128.ibm.com/developerworks/patterns/, provide: (1) technical modeling design as well as upper case mission business modeling patterns that identify the interaction between users, businesses, and associated technological components that access relevant data; (2) integration patterns that connect other business patterns together to create applications with advanced functionality; (3) composite patterns, which are combinations of business patterns and integration patterns that have themselves become commonly used types of e-business applications; (4) custom designs, which were developed to solve the e-business problems of one specific company, or perhaps several enterprises with similar problems; and (5) lower case application and runtime (i.e., design) patterns, which are driven by the customer's requirements and describe the shape of application details and the supporting runtime components needed to build the e-business application.

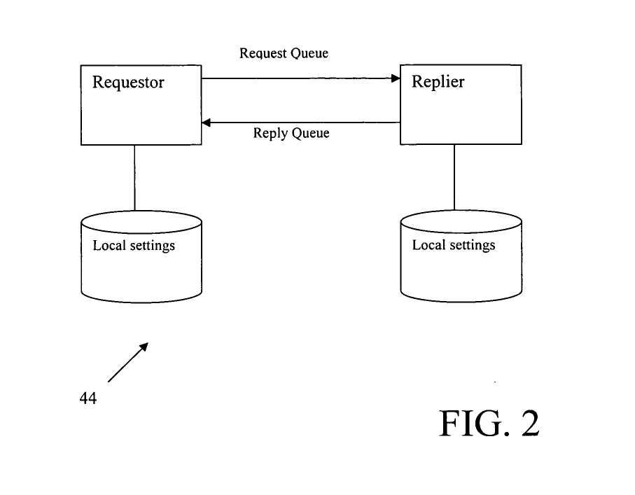

An illustrative pattern is depicted in FIG. 2 that provides a point-to-point “request/reply” lower case application pattern 44, which allows users to directly address other users on the network using simple point-to-point synchronous communications. Obviously, it should be understood that for the purposes of this invention, the number, type and sources of patterns and pattern libraries for designing applications is not limited to any particular number, type or source.

Included in the pattern generation system 10 of FIG. 1 are a design interface 12, a modeling system 24, a framework integration system 18, and an architecture product library 14. Design interface 12 provides a system designer access to the modeling system 24, in which patterns that meet the IT system requirements 20 can be identified and selected. Framework integration system 18 provides an application technique that defines a set of build concepts 42 (i.e., a subset of patterns) that are available to the modeling system 24 for a given enterprise reference model framework 22. The architecture product library 14 provides a generic source of patterns, which may for example be derived from an RUP (rational unified process) SE™ pattern library, the GANG OF FOUR™ pattern library, IBM™ Patterns for eBusiness library, etc.

Based on the IT system requirements 20, the system designer selects patterns 38 that are made available by the framework integration system 18 to the modeling system 24. An available subset of build concepts 42 (i.e., patterns) are dictated by a selected enterprise reference model framework 22 (“framework”). As noted above, the public sector information technology systems are typically required to be designed in accordance with a defined enterprise reference model framework, such as the Federal Enterprise Architecture Framework (FEAF), the Department of Defense Architecture Framework (DODAF) and the Treasury Enterprise Architecture Framework (TEAF). Each of these frameworks provide general guidelines regarding the implementation of a system, but fail to provide the low level technical implementation details necessary to implement such a system.

The illustrative embodiment of FIG. 1 includes a framework selection system 16 that allows the designer to select the appropriate enterprise reference model framework 22 for the particular application being designed. Based on the selection, the architecture product library 14, which contains the pattern libraries, will be essentially restricted by an architecture model 28 that dictates a set of model concepts 40 for the selected framework, and ultimately aligns to a set of integration system capabilities 26 that dictates a subset of build concepts 42 for the selected framework. Model concepts 40 may be extrapolated from the particular framework as both non-functional requirements and as principals of architecture to be used for the particular system being designed. As noted above, the build concepts 42 constrain relevant subsets of patterns to the modeling system 24 pertinent to the selected framework. The build concepts 42 are where a transcoding between the patterns occurs to provide constraints that limit the pattern choices. This process could be automated or manual.

Architecture model 28 is the stabilized result of applied model concepts 40. Model concepts 40 are based on the objective stated principles of architecture that an organization is trying to achieve, such as Web Services concepts (e.g., HTTP, XML, SOAP, etc.), client server concepts (e.g., Microsoft COM models using Visual Basic), Mainframe oriented concepts, (e.g., IBM Customer Information Control System “CICS”), etc. Integrated system capabilities 26 generally refers to concepts such as scalability, reliability, robustness, etc., which are generally derived from non-functional system requirements as driven by the needs of the organization under study. Build concepts 42 are the application of those patterns in architecture at upper (i.e., system and business) and lower (i.e., design) levels that are appropriate after reasoned analysis of the confluence of integrated system capabilities 26 and model concepts 40 is ascertained.

Accordingly, allowing a particular pattern to act as a “pleomorph” is fully realized by framework integration system 18 in as much as the patterns can typically be applied to a variety of potential solution sets from a data and functionality standpoint. However, the ability to utilize the pleomorphic archetype greatly simplifies the analysis necessary to address the particular problem set under study.

A chief goal of the federal legislation surrounding the aforementioned frameworks is to be able to provide integrated systems. Because technology has consistently been advancing in waves of new approaches, governmental entities require the integration of the previous technology with the evolutionary one. This goal has a character in information technology architecture that has a physical instance at any particular point in time. To achieve this, integration system capabilities 26 are drawn from the selected domain under study (i.e., selected framework) as non-functional requirements and as architectural principles to shape and constrain the series of integration related artifacts (e.g., meta-models, patterns, etc.) that are relevant to the selected framework 22. Accordingly, integrated system capabilities 26 provide the domain relevant integration models for integrating different patterns and components within the context of a selected framework.

Architecture model 28 provides the necessary applied structure at the system architecture level. Known system design and architecture tools, such as the RATIONAL™ Software Architecture Tool Suite, come with a set of tooling technologies to assist in the development and maintenance of a system level repository of artifacts. The choice may for example be based on an artifact character required, for instance operational views (OV) and system views (SV) in the case of Popkin oriented tooling views, or UML (unified modeling language) models in the case of the IBM Rational RUP.

As noted, modeling system 24 provides the mechanism through which a system designer can architect an application via the use of patterns 38. Patterns 38 form the basis of the build concepts 42 set forth within the framework integration system 18. In this illustrative embodiment, modeling system 24 comprises a set of subsystems or constructs that can be used to design and select patterns at different levels of functionality. These subsystems include a business/mission modeling construct 30, a service modeling construct 32, a technical modeling construct 34, and an information architecture modeling construct 36. Each modeling subsystem relates to the decomposed areas of import to an enterprise seeking to maximize integration with both systems and mission elements. The associated methods found within each class of patterns are where the lowest level of pattern decomposition is found.

The business/mission modeling construct 30 provides the analysis patterns and business patterns that describe the mission operations of the enterprise. For instance, potential business missions could include a search engine, an auction site, a stock trading site, a retail business, etc. Accordingly, business/mission modeling construct 30 allows the designer to select the appropriate high level business pattern(s) that represent the business mission of the enterprise.

The service modeling construct 32 provides the component, architecture and system patterns, which describe service classifications to the components. For instance, it allows the designer to select whether a component is to be implemented using Web Services, data access services, data federation services, transcoding services, messaging services, collaboration services, etc.

The technical modeling construct 34 provides the integration tree interface patterns, which dictate categorization of standards, specifications and technologies. Namely, the technical modeling construct 34 allows the designer to specify connectivity types and employs the lower case design patterns to describe a particular interface, connection or linkage.

Finally the information architecture modeling construct 36 provides the data topologies, ontologies, schemas and data patterns. Thus, the information architecture modeling construct 36 allows the designer to specify the data structures and data architectures to be used within the application.

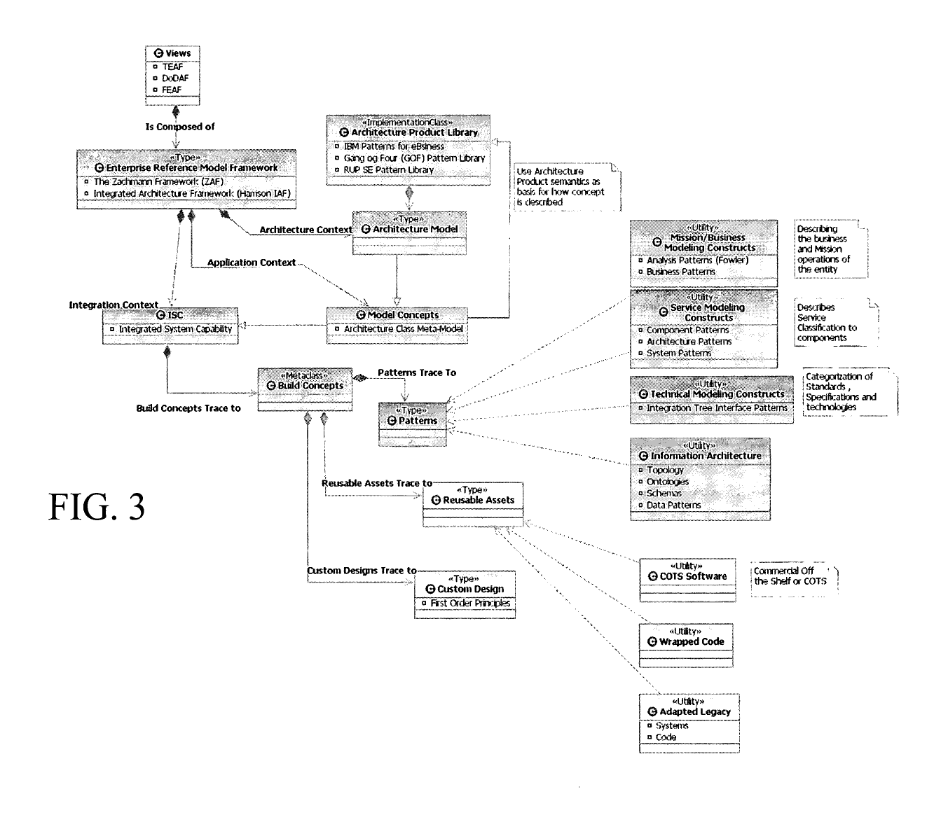

FIG. 3 depicts an object-oriented view for implementing the pattern generation system 10 described above. As shown, the Type “Patterns” are traced to a MetaClass “Build Concepts,” which are traced to Integrated System Capability (ISC). ISC is traced to both the Type “Enterprise Reference Model Framework” and Model Concepts. Model Concepts, which comprises an Architecture Class Meta-Model, can be traced to Type “Enterprise Reference Model Framework” and Type “Architectural Model.” Type “Architectural Model” is traced to the Implementation Class “Architectural Product Library.” The Type “Enterprise Reference Model Framework” is composed of views that for instance include FEAF, DoDAF and TEAF.

The MetaClass “Build Concepts” is linked to Type “Custom Designs” and Type “Reusable Assets” that includes, e.g., commercial off the shelf software, wrapped code, and adaptive legacy systems and code. The Type “Patterns” are linked to the Utility categories “Mission Reference Model,” “Service Reference Model,” “Technical Reference Model,” and “Information Architecture.”

It is understood that the pattern generation system 10 described above may be implemented within any type of computer system, e.g., a desktop, a laptop, a workstation, handheld device, client, server, etc. Such a computer system generally includes a processor, input/output (I/O), memory, and bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. The bus provides a communication link between each of the components in the computer system and likewise may comprise any known type of transmission link, including electrical, optical, wireless, etc. Although not shown, additional components, such as cache memory, communication systems, system software, etc., may be incorporated into the computer system.

Access to computer system may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should also be appreciated that the teachings of the present invention could be offered as a business method on a subscription or fee basis. For example, a computer system comprising a pattern generation system could be created, maintained and/or deployed by a service provider that offers the functions described herein for customers. Furthermore, such a system could be integrated with an existing product, such as the Rational RSA Tooling system using “snap-in” products and wizards that would lead a user through the processes described above. That is, a service provider could offer to provide an online system for generating patterns based on a selected enterprise reference model framework as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware and software for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for processing patterns that provide technological implementation details of an enterprise application, comprising:
an architecture product library having patterns that define reusable assets for use in modeling enterprise components and systems;
a framework integration system that defines a subset of patterns from the architecture product library for a predefined enterprise reference model framework; and
a system for modeling an enterprise application within the context of the predefined enterprise reference model framework by using patterns selected from the subset of patterns.

2. The system of claim 1, wherein the architecture product library includes patterns selected from the group consisting of: business patterns, integration patterns, composite patterns, custom designs, and runtime patterns.

3. The system of claim 1, wherein the framework integration system defines an architecture model for the predefined enterprise reference model framework.

4. The system of claim 1, wherein the framework integration system defines a set of integration system capabilities for the predefined enterprise reference model framework.

5. The system of claim 1, wherein the framework integration system defines a set of model concepts and build concepts for the predefined enterprise reference model framework.

6. The system of claim 1, wherein the system for modeling the enterprise application includes:
a business/mission modeling system for generating a pattern that describes a set of mission operations of an enterprise;
a service modeling system for generating patterns that describe service classifications of the enterprise application;
a technical modeling system for generating integration patterns of the enterprise application; and
an information architecture modeling system for defining data patterns for the enterprise application.

7. The system of claim 1, wherein the predefined enterprise reference model framework is selected from the group consisting of: a Federal Enterprise Architecture Framework (FEAF), a Department of Defense Architecture Framework (DoDAF), and a Treasury Enterprise Architecture Framework (TEAF).

8. The system of claim 1, further comprising a system for selecting an enterprise reference model framework from a plurality of enterprise reference model frameworks.

9. The system of claim 1, wherein the patterns comprise upper case patterns and lower case patterns, and wherein the subset of patterns comprises lower case patterns.

10. A computer program product stored on a computer readable medium for processing patterns that provide technological implementation details of an enterprise application, comprising:
program code configured for accessing an architecture product library having patterns that define reusable assets for use in modeling enterprise components and systems; and
program code configured for defining a subset of patterns from the architecture product library for a predefined enterprise reference model framework.

11. The computer program product of claim 10, further comprising program code configured for modeling an enterprise application within the context of the predefined enterprise reference model framework by using patterns selected from the subset of patterns.

12. The computer program product of claim 10, wherein the program code configured for defining a subset of patterns defines an architecture model for the predefined enterprise reference model framework.

13. The computer program product of claim 10, wherein the program code configured for defining a subset of patterns defines a set of integration system capabilities for the predefined enterprise reference model framework.

14. The computer program product of claim 10, wherein the program code configured for defining a subset of patterns defines a set of model concepts and build concepts for the predefined enterprise reference model framework.

15. The computer program product of claim 10, wherein the program code configured for modeling the enterprise application includes:
a business/mission modeling system for generating a pattern that describes a set of mission operations of an enterprise;
a service modeling system for generating patterns that describe service classifications of the enterprise application;
a technical modeling system for generating integration patterns of the enterprise application; and
an information architecture modeling system for defining data patterns for the enterprise application.

16. The computer program product of claim 10, wherein the predefined enterprise reference model framework is selected from the group consisting of: a Federal Enterprise Architecture Framework (FEAF), a Department of Defense Architecture Framework (DoDAF), and a Treasury Enterprise Architecture Framework (TEAF).

17. The computer program product of claim 10, further comprising program code configured for selecting an enterprise reference model framework from a plurality of enterprise reference model frameworks.

18. The computer program product of claim 10, wherein the patterns comprise upper case patterns and lower case patterns, and wherein the subset of patterns comprises lower case patterns.

19. A method for processing patterns that provide technological implementation details of an enterprise application, comprising:
providing an architecture product library having patterns that define reusable assets for use in modeling enterprise components and systems;
defining a subset of patterns from the architecture product library for a predefined enterprise reference model framework; and
modeling an enterprise application within the context of the predefined enterprise reference model framework by using patterns selected from the subset of patterns.

20. The method of claim 19, wherein the architecture product library includes patterns selected from the group consisting of: business patterns, integration patterns, composite patterns, custom designs, and runtime patterns.

21. The method of claim 19, wherein the step of defining a subset of patterns defines an architecture model for the predefined enterprise reference model framework.

22. The method of claim 19, wherein the step of defining a subset of patterns defines a set of integration system capabilities for the predefined enterprise reference model framework.

23. The method of claim 19, wherein the step of defining a subset of patterns defines a set of model concepts and build concepts for the predefined enterprise reference model framework.

24. The method of claim 19, wherein the step of modeling the enterprise application includes:
generating a pattern that describes a set of mission operations of an enterprise;
generating patterns that describe service classifications of the enterprise application;
generating integration patterns of the enterprise application; and
defining data patterns for the enterprise application.

25. The method of claim 19, wherein the predefined enterprise reference model framework is selected from the group consisting of: a Federal Enterprise Architecture Framework (FEAF), a Department of Defense Architecture Framework (DoDAF), and a Treasury Enterprise Architecture Framework (TEAF).

26. The method of claim 19, further comprising program the step of selecting an enterprise reference model framework from a plurality of enterprise reference model frameworks.

27. The method of claim 19, wherein the patterns comprise upper case patterns and lower case patterns, and wherein the subset of patterns comprises lower case patterns.

28. A method for deploying an application for an architecture pattern processing system, comprising:
providing a computer infrastructure being operable to:
access an architecture product library having patterns that define reusable assets for use in modeling enterprise components and systems;
define a subset of patterns from the architecture product library for a predefined enterprise reference model framework; and
model an enterprise application within the context of the predefined enterprise reference model framework by using patterns selected from the subset of patterns.

29. Computer software embodied in a propagated signal for implementing a pattern processing system, the computer software comprising instructions to cause a computer to perform the following functions:
access an architecture product library having patterns that define reusable assets for use in modeling enterprise components and systems; and
define a subset of patterns from the architecture product library for a predefined enterprise reference model framework.
